(19) United States
(12) Patent Application Publication
(10) Pub. No.: US 2012/0094263 A1
(43) Pub. Date: Apr. 19, 2012

(54) VIDEO GAMES FOR TRAINING SENSORY AND PERCEPTUAL SKILLS

(75) Inventor: Aaron Seitz, Riverside, CA (US)

(73) Assignee: THE REGENTS OF THE UNIVERSITY OF CALIFORNIA, Oakland, CA (US)

(21) Appl. No.: 13/276,529

(22) Filed: Oct. 19, 2011

Related U.S. Application Data
(60) Provisional application No. 61/394,700, filed on Oct. 19, 2010.

(51) Int. Cl. G09B 5/00

(52) U.S. Cl. 434/307 R

(57) ABSTRACT

Provided are sensory and perceptual training methods and systems. The disclosure provides a video game or video entertainment task-action process for promoting sensory learning and perception learning.

### CROSS REFERENCE TO RELATED APPLICATIONS

This application claims priority to U.S. Provisional Application Ser. No. 61/394,700, filed Oct. 19, 2010, the disclosure of which is incorporated herein by reference.

### TECHNICAL FIELD

Provided are methods and systems for improving sensory and perceptual skills using a video and/or acoustic input/output device.

### BACKGROUND

Over the last half-century, the study of perceptual learning has proven to be increasingly valuable. Enhanced perceptual abilities can benefit almost all aspects of our lives; such as improved visual-motor skills, improved surgical skills, improved reading skills, etc. Currently there are many studies that demonstrate improvements of a wide range of perceptual abilities. However, while the existence and benefits of perceptual learning is clear, the processes by which it can be acquired are not. Training on a perceptual task does not always result in perceptual improvements and in many cases weeks or more of training are required to obtain significant perceptual improvements. Of note, recent research has demonstrated playing action video games leads to enhanced attention and perceptual improvements.

### SUMMARY

Procedures used in the field of perceptual learning can be made into video games in order to create products that are fun to use and that will enhance sensory and perceptual abilities of the user. Using methodologies of task-irrelevant learning (TIL) basic perceptual features paired with important game elements are shown to better tune the perceptual systems to process those features. Additional research methodologies showing multisensory facilitation (MF) of visual learning can be used to design games that incorporate sounds that well match the visual display and that help to facilitate visual learning processes. MF and TIL procedures can be built into existing games. Furthermore procedures that currently are used to produce perceptual learning (such as Gabor detections task, motion discrimination tasks, visual search tasks, etc.) can be built into a gaming framework to increase the motivation of participants. MF and TIL can be added and used in combination with other perceptual learning tasks (including procedures to train non-visual skills; such as auditory or tactile learning).

These games will have significant advantages over standard perceptual learning paradigms because they will be fun for the participants and will incorporate multiple principles of perceptual learning to maximize the benefits to the participant. Furthermore, assessments perceptual abilities such as visual acuity, contrast discrimination, motion discrimination, and attentional abilities can be built directly into the games in order to give participants feedback on their progress and for developers to track the benefits of the games.

The disclosure provides a method for improving sensory and perceptual skills in a subject, comprising exposing the subject to a video and/or acoustic output device with an input device operably connected to a computer to present a video/computer game comprising a laboratory procedure proven to produce perceptual learning. In one embodiment, the method comprises a TIL procedure. In another embodiment, the method comprises a MF procedure. In another embodiment, the exposing comprises provide a first stimulus provided by the video and/or acoustic output device that requires an action task by the subject, providing a second stimulus and reinforcing the subject upon completion of the action task. In another embodiment, the second stimulus is not associated with the action task and is presented with the first stimulus and/or the reinforcement and this procedure can be repeated. In yet another embodiment, the first stimulus is a visual stimulus and the second stimulus is a visual stimulus. In yet a further embodiment, the first stimulus is a visual stimulus and the second stimulus is an auditory stimulus. In another embodiment, the first stimulus is an auditory stimulus and the second stimulus is a visual stimulus. In yet another embodiment, the first stimulus and second stimulus are naturally associated stimuli. In another embodiment, the first stimulus and second stimulus are movement associated. In yet another embodiment, the first and second stimuli are repeated one or more times in combination. In yet another embodiment, the second stimulus is auditory, visual or auditory and visual and is used to enhance processing of task-relevant stimuli. In yet another embodiment, the method can further comprise one or more additional stimuli presented along with the first and second stimuli enhanced processing of sensory.

The disclosure also provides computer implemented method of the disclosure. In one embodiment, the computer implement method comprises a video game. In another embodiment the videos game comprises a TIL and/of MF learning paradigm.

The disclosure also provides a computer-readable memory medium that stores program instructions for improving sensory and perceptual skills of a subject, comprising exposing the subject to a video and/or acoustic output device operably connected to a computer to display a video/computer game, visually providing a first stimulus that requires an action task by the subject, providing a second stimulus not associated with the task and reinforcing the subject upon completion of the action task, and repeating said visually presenting and presenting of said second stimulus, said task performance, and said reinforcement.

The disclosure also provides a method, computer implemented method or computer game for stimulating perceptual learning comprising providing a task and a non-task oriented stimulus requiring a response with a learning aspect.

The details of one or more embodiments of the disclosure are set forth in the accompanying drawings and the description below. Other features, objects, and advantages will be apparent from the description and drawings, and from the claims.

### DETAILED DESCRIPTION

As used herein and in the appended claims, the singular forms “a,” “and,” and “the” include plural referents unless the context clearly dictates otherwise. Thus, for example, reference to “a video device” includes a plurality of such video devices and reference to “the sound” includes reference to one or more sounds, and so forth.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

Any publications discussed above and throughout the text are provided solely for their disclosure prior to the filing date of the present application. Nothing herein is to be construed as an admission that the inventors are not entitled to antedate such disclosure by virtue of prior disclosure.

The disclosure provides optimized video games that can improve the sensory/perceptual abilities of players of those games. Modern research of perceptual learning has focused on how people are able to gain improvements in the basic building blocks of perception. In the case of vision, these include visual acuity, contrast sensitivity, motion sensitivity and visual attention. Visual acuity is our ability to discriminate small objects and is basic measure of vision used by optometrists when determining a patient's eye-glass prescription. Contrast sensitivity is our ability to discriminate differences in light intensities or colors and is critical to our ability to discriminate objects from their backgrounds or from other objects. Motion sensitivity is our ability to detect the movement of objects and is critical visual ability that not only helps us discriminate objects but also contributes to balance and peripheral awareness. Visual attention is our ability to focus on and specifically process those aspects of the visual scene that are most relevant to our task at hand. These four visual abilities are foundational to all aspects of vision and can be optimized by the methods and systems of the disclosure. Equivalant abilities for other sensory modalities (such as audition and haptics) can be addressed through similar procedures.

The disclosure is based, in part, upon the observation that participants of various video games can gain perceptual benefits whether or not they are aware of the presentation of the trained stimuli as long as the trained stimuli are presented at the same time as a rewarding event. For example, subjects can even learn to better discriminate subliminally presented motion or orientation patterns, or patterns of sounds, when these patterns are paired with the targets of a subjects' main task. Reinforcement (something that is highly present in video games) is a mechanism to perceptual learning. Notably, many perceptual learning training paradigms are not very motivating and are lacking in this reinforcement. Furthermore existing video games do not strategically pair stimuli that would be beneficial for participants to learn with the reinforcement received in the game. Coordinated auditory and visual stimulation can lead to faster acquisition of perceptual learning and better overall improvement; however uncoordinated auditory and visual stimuli do not. Based upon this research, a key to creating a video game is to build in the learning protocols shown to be key to perceptual learning into the video game. This includes pairing stimuli to be learned with reinforcing aspects of the game and carefully coordinating auditory and visual game stimuli so that the senses work together and promote learning.

In addition to training methodologies (outlined above) one key technology that is important to a product that claims to improve sensory abilities is to build in assessments and provide feedback to keep participants aware of their improvements. This can be accomplished in the context of a game by presenting targets to the participant that vary in parameters related to the abilities to be learned. For example, in the case of vision, stimuli can vary in their contrast (for contrast sensitivity), spatial frequency (for acuity), and motion coherence (for motion sensitivity) and in rapid succession and with distractors (for attention). Depending on the application this can be done within the main game or within an ancillary game. These assessments can also be uploaded to a central research server so that overall benefits to the games user base can be tracked. This information can be used in clinical settings to track patient improvements as well as for research purposes to gain to better understanding of how game elements contribute to learning and for improving the game.

Research of task-irrelevant learning (TIL) has demonstrated that sensory improvements can occur without attention being directed to the learned stimuli. For example, sensitivity enhancement for particular motion directions occurred as the result of temporal-pairing between the presentation of a subliminal, task-irrelevant, motion stimulus and a task-target. These results demonstrate that TIL does not occur as a result of purely passive exposure, but that the irrelevant feature must be related to task performance. These results led to the idea that TIL is gated by confluence between a spatially diffusive task-related signal and a task-irrelevant feature signal. Later research confirmed this idea by demonstrating that TIL can arise from pairing a stimulus with a liquid reward. This research shares common elements to theories of reinforcement learning and in this regard have a high degree of ecological validity. Namely, that learning is gated by behaviorally relevant events (rewards, punishment, novelty, etc). At these times reinforcement signals are released to better learn aspects of the environment (even those for which the organism is not consciously aware) that are predictive or co-vary with the event. For example, in a natural environment a target (e.g., a predator) to which one needs to direct attention is usually presented in the same or similar context. Thus, gaining higher sensitivity to features in such a context may lead one to more easily notice that he/she is in the environment in which a target tends to appear and to better recognize the target.

The TIL paradigm has a number of advantages for the use in video game applications.
1) The learned stimuli are incidental to the participant's main task. Thus, it is relatively straight forward to add stimulus features to be learned to an existing task.
2) TIL can occur for stimuli that are unnoticed by the participant. Thus, stimuli that are added to a game will not be distracting to that game.
3) TIL occurs due to reinforcement from the participant's task. Video games involve many reinforcing elements and provide a rich opportunity for learning.
4) TIL has been found to be as strong as direct training on the same stimuli. This shows that TIL is an effective learning paradigm and with the large amount of reinforcement found in a video game should be close to an optimal learning paradigm.

Research of Multisensory Facilitation (MF) of Learning shows that visual learning was superior after multisensory vs. unisensory training procedures. In these studies, a coherent motion detection and discrimination task was used. The subjects conducted a task where they were required to report which of the two intervals contained a moving visual stimulus. Some subjects did this task in silence (Vonly), some with a sound moving in the same directions as the visual stimulus (AVcong) and some with the visual stimulus moving in incongruent directions (AVincong). The AVcong group showed improved learning compared to the Vonly group both within the first session and across the 10 training sessions. However, these benefits of multisensory training were specific to the AVcong group, whereas the AVincong group performed similarly to the Vonly group. Additionally, the results of a direction test showed that performance was significantly greater for the trained directions than the untrained directions, indicating that the observed improvements in performance reflect perceptual learning. In an fMRI study, using this paradigm, data demonstrated training-induced changes in a large system of brain areas that were specific to the trained direction of motion; including brain areas MT+, occipital lobe, auditory cortex, frontal lobe, pSTG, and anterior temporal lobe. These results demonstrate significant changes in brain processing due to multisensory training.

The MF paradigm also has key advantages for the use in video game applications.
1) Video games typically involve both auditory and visual stimuli. The MF research shows that learning will be best if the auditory stimuli are designed to properly complement the visual stimuli (such as shared spatial temporal features such as the case of the motion stimuli in the MF research).
2) The use of sounds that are designed to match the spatial location of the game targets are likely to enhance game-play as well as learning. It is thought that the MF paradigm is taking advantage of natural learning mechanisms that are designed to enhance processing of stimuli that are coordinated across the senses.

In one embodiment, the auditory and visual stimuli are referred to as naturally associated, in this context the stimuli are connected as they would be in nature. For example, the visual stimulus is a cow and the auditory stimulus is the sound a cow makes. In another embodiment, the visual and auditory sounds are spatially/temporally associated. In this embodiment, the visual stimuli and auditory stimuli are presented at the same time and location, and if moving, move together. Accordingly, in various embodiments the visual elements are properly supported by the auditory elements (and viseversa when auditory skills are to be trained).

It should also be noted that the specific embodiments disclosed herein are meant to be exemplary, and that other repetition-based cognitive training exercises using stimuli with multiple stimulus sets may be used as desired, including in combination. In other words, the exercises described herein are but specific examples of perceptual training exercises using a computing system to present sensory stimuli to a participant, record the participant's responses, and modify some aspect of the sensory stimuli based on these responses, where these method elements are repeated in an iterative manner using multiple sets of stimuli to improve the participant's ability to process perceptual information. Note particularly that such training using a variety of exercises, possibly in a coordinated manner, is contemplated.

Those skilled in the art should appreciate that they can readily use the disclosed conception and specific embodiments as a basis for designing or modifying other structures for carrying out the same purposes of the present invention without departing from the spirit and scope of the invention as defined by the appended claims. For example, various embodiments of the methods disclosed herein may be implemented by program instructions stored on a memory medium, or a plurality of memory media.

A video gaming system is an interactive entertainment computer or electronic device that produces a video display signal which can be used with a display device (a television, monitor, etc.) to display a video game or directly on a portable device like smart phone or PDA (Personal Digital Assistant). The term “video game console” is used to distinguish a machine designed for consumers to buy and use solely for playing video games from a personal computer, which has many other functions. Video gaming system can be connected to the Internet. The software can be further configured to interact with peer systems or central server. Video gaming system can be coupled with general purpose (key board, mouse, monitor, joystick, camera, microphone) and specialized (position sensors, accelerometers, voltage sensors, heart rate monitors, blood pressure modules) peripheral devices. A computer readable program of the disclosure can either reside on video gaming system or on the server or on a readable media.

The disclosure is illustrated in the following examples, which are provided by way of illustration and are not intended to be limiting.

### EXAMPLES

### Incorporation into an Existing Video Game

Both TIL and MF can easily be incorporated into most conventional video games. This is an advantageous route since conventional games have already been found to boost attentional and perceptual abilities and conventional games are usually designed to with a lot of reinforcement in mind (this helps encourage game-play).

In the case of TIL parathreshold or subthreshold gabor patterns and motion patterns (or other basic sensory stimulus features) can be superimposed onto game targets at time of presentation and/or at times of target acquisition. For example, if the participant is meant to shoot a “bad-guy” the learning stimulus can be presented when the bad-guy appears on the screen and/or when the bad-guy is successfully shot (both of these are events correlated with the released of reinforcement signals in the brain).

In the case of MF, sounds can be used to help alert the participant to the presence and location of the target. Sounds can be played cueing the presence of the target with the most learning expected in the case that the sounds are informative regarding the identity of the target (ie different targets have different sounds) and that the sounds are designed such that significant learning is not required to discover the relationship between sound and the target (ie a cow should make “cow sounds”). A system with two speakers on symmetrically placed around the screen is recommended for best results such that the sound can be spatially localized to the target location by use of interaural intensity differences, however, even without a spatial cue, MF is expected.

### Design of New Games Specifically Based on Perceptual Learning Procedures

There are numerous perceptual learning paradigms that are used in research labs that are proven to produce benefits in sensory processing, however, many of these procedures are unmotivating to participants and should produce more learning (and participant retention) if they were adapted to a gaming framework. Furthermore many of these procedures do not currently take advantage of MF and TIL. The disclosure describes applications in which these learning paradigms are altered to take advantage of the motivational framework of video games and augmented with MF and TIL. This can be done by combining a couple existing perceptual learning procedures with known benefits, however, other combinations using similar principles can also be made.

One of the most basic perceptual learning tasks is to practice discrimination oriented Gabor patterns (a basic visual feature) that vary in size, orientation, spatial frequencies and contrast. In the typical setting Gabors are presented alone on a gray screen or with flankers and participants are asked to report when they see the Gabor patterns. This task can be combined with another standard perceptual learning task requires subjects to search for odd-elements in an array of differently oriented bars. Both procedures result in long-term benefits to sensory abilities. However, while practice with Gabors has proven benefits for contrast discrimination and acuity, this typically is only done at a single location in the visual field and such learning effects may not fully transfer to other parts of the visual field. The use of a visual search task will ensure that learning generalizes over a wider part of the visual field. Also, the visual search task requires that participants attend to a wide area of the display and thus attentional as well as perceptual abilities can be trained.

An example application is to build a simple game around the search task to improve the motivation of subjects (these tasks are typically very boring). For example, the Gabor stimuli can be distinguishing features of other objects (ie. They can be placed on the clothing of people, or as targets on objects) and thus the basic task of finding and discriminating the Gabor pattern can be built into a game where a variety of targets must be found and responded to. To make the game difficult (important for motivation) the contrast can be lowered, spatial frequency raised, size decreased, and presentation time reduced to make the target difficult to detect, etc. These parameters can be adapted (singly or together) to the participant's performance level to best produce learning. With this game MF can be added by adding sounds that help alert participants to the presence and location of the target. Likewise, TIL can be added (as above) by pairing subtle basic sensory patterns with the onset of the targets and with correct responses to the targets.

### Procedures to Track Performance Metrics

Procedures to test for benefits of training games can be highly similar to the actual training and in some case directly built into the training procedure. For example, training games will typically present stimuli that are adaptive to the performance of the subject (adaptive difficulty) or present a range of difficulties to the subject (method of constant stimuli). To track performance, all that is required is that the experimental program records performance metrics (such as accuracy, threshold and reaction time) in reference to the stimulus parameters that were presented on each trial. In this way performance metrics can be tabulated for each training session and compared across sessions. However, in some cases transfer to other tasks will need to be assessed. For example in training sessions visual acuity might be tracked as a function of the spatial frequency of a Gabor pattern and in a testing session, Visual Acuity could be measured using a Snellen type procedure. For this letters of different sizes can be presented as game targets and Snellen acuity could be measured in a gaming context. Likewise, attentional abilities can be assessed by presenting targets at a rapid rate and at various distances from the center of view and tracking the rate and useful field of view in which the participant can accurately respond. Thus assessments can either take the form of measurements during training, a battery of tests that are periodically conducted, or both. These assessments will be most accurate if the participant conducts these tests in a consistent setting (same computer set-up, with fixed lighting and at a consistent distance from the screen), and participants will be instructed on how to calibrate their displays for best results. However, assessments will have some tolerance for setting variance provided that settings do not change systematically across the training session.

Procedures used in the field of Perceptual Learning can be made into video games in order to create products that are fun to use and that will enhance perceptual abilities of the user. Using methodologies of task-irrelevant learning (TIL) basic perceptual features can be paired with important game elements in order to better tune the perceptual systems to process those features. Additional research methodologies showing multisensory facilitation (MF) of learning can be used to design games that incorporate sounds that well match the visual display and that help to facilitate learning processes. MF and TIL procedures can be built into existing games. Furthermore procedures that currently are used to produce perceptual learning (such as Gabor detections task, motion discrimination tasks, visual search tasks, etc) can be built up into a gaming framework to increase the motivation of participants. MF and TIL can be added and used in combination with other perceptual learning tasks.

These games will have significant advantages over standard perceptual learning paradigms because they will be fun for the participants and will incorporate multiple principles of perceptual learning to maximize the benefits to the participant. Furthermore, assessments of learning such as visual acuity, contrast discrimination, motion discrimination, or equivalents for other senory modalities, and attentional abilities can be built directly into the games in order to give participants feedback on their progress and for clinicians to track patient progress and for researchers and developers to track the benefits of the games and to improve them accordingly.

1. A method for improving sensory and perceptual skills in a subject, comprising exposing the subject to a video and/or acoustic output device with an input device operably connected to a computer to present a video/computer game comprising a laboratory procedure proven to produce perceptual learning.

2. The method of claim 1, wherein the laboratory procedure comprises a task irrelevant learning (TIL) procedure.

3. The method of claim 1, wherein the laboratory procedure comprises a MF procedure.

4. The method of claim 1, wherein a first stimulus is provided by the video and/or acoustic output device that requires an action task by the subject, providing a second stimulus and reinforcing the subject upon completion of the action task.

5. The method of claim 4, wherein the second stimulus is not associated with the task can be presented with the first stimulus and/or the reinforcement and this procedure can be repeated.

6. The method of claim 4, wherein the first stimulus is a visual stimulus and the second stimulus is a visual stimulus.

7. The method of claim 4, wherein the first stimulus is a visual stimulus and the second stimulus is an auditory stimulus.

8. The method of claim 4, wherein the first stimulus is an auditory stimulus and the second stimulus is a visual stimulus.

9. The method of claim 7, wherein the first stimulus and second stimulus are naturally associated stimuli.

10. The method of claim 7, wherein the first stimulus and second stimulus are spatially/temporally associated.

11. The method of claim 4, wherein the first and second stimulus are repeated one or more times in combination.

12. The method of claim 4, wherein the second stimulus is auditory, visual or auditory and visual and is used to enhance processing of task-relevant stimuli.

13. The method of claim 4, further comprising one or more additional stimuli presented along with the first and second stimuli enhanced processing of sensory.

14. A computer-implemented method for carrying out the method of claim 1.

15. A computer-readable memory medium that stores program instructions for improving sensory and perceptual skills of a subject, comprising exposing the subject to a video and/or acoustic output device operably connected to a computer to display a video/computer game, visually providing a first stimulus that requires an action task by the subject, providing a second stimulus not associated with the task and reinforcing the subject upon completion of the action task, and repeating said visually presenting and presenting of said second stimulus, said task performance, and said reinforcement.

16. A method, computer implemented method or computer game for stimulating perceptual learning comprising providing a task and a non-task oriented stimulus requiring a response with a learning aspect.
